(19) United States
(12) Patent Application Publication
(10) Pub. No.: US 2003/0151890 A1
(43) Pub. Date: Aug. 14, 2003

(54) Protective sheath for portable electronic device and method for making same

(76) Inventors: Tony Huang, Shenzhen (CN); John Huang, Shenzhen (CN); JianLi Ma, Shenzhen (CN); MeiLin Wang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/271,087

(22) Filed: Oct. 15, 2002

(30) Foreign Application Priority Data
Feb. 8, 2002 (TW) 91102462

(51) Int. Cl. G06F 1/16; B65D 73/00

(52) U.S. Cl. 361/683; 206/470; 206/471

(57) ABSTRACT

A protective sheath (1) for a personal digital assistant (3) includes a lower cover (13) and an upper cover (11). The upper cover includes a window (111) made of transparent plastic material, and two side wings (112) made of elastomer. The window includes a plastic base (114), and a coating including silicon oxide (113) on a surface of the base. Adherence between the base and the coating is very firm. The window is highly transparent, and has a very smooth and even surface, and has excellent wear-resistance. A method for forming the protective sheath includes the steps of: (1) injection molding the plastic base; (2) pre-treating the base; and (3) putting the base into a vacuum chamber for plasma chemical vapor deposition (PCVD) treatment, whereby the coating including silicon oxide is formed on the surface of the base.

### BACKGROUND OF THE INVENTION

1. Field of the Invention

The present invention relates to a protective sheath for a portable electronic device, and particularly to a transparent protective sheath and a method for forming the same.

2. Related Art

Electronic devices, such as personal digital assistants (PDAs), are widely used nowadays. PDAs include palmtop computers, handheld computers, notebook computers, and other types of portable microprocessor-based devices.

PDAs are used to perform a full array of computing tasks in all kinds of environments. Some PDAs simply provide the same computing functions traditionally found in a desktop computer. Other PDAs take advantage of their inherent portability by incorporating specialized data collection functions, or by incorporating communication links with other devices.

A conventional PDA is encased in a protective sheath, to protect the PDA from being scratched. A conventional protective sheath has a plastic base, and a decorative coating formed thereon such as an attractive surface feature. However, after prolonged use, the conventional coating is prone to degenerate or become detached from the plastic base. In addition, during manufacture, it is difficult to distribute the coating uniformly on the surface of the base. That is, it is difficult to obtain an attractive surface appearance for the protective sheath of the PDA. Furthermore, the coating is conventionally applied to the base by spraying. This procedure is laborious and complicated. The coating formed is unduly thick, which increases costs. Moreover, if the protective sheath is made of transparent material, the coating adversely affects transparency of the protective sheath.

An improved protective sheath for a PDA which overcomes the above-mentioned problems is desired.

### BRIEF SUMMARY OF THE INVENTION

Accordingly, an object of the present invention is to provide a protective sheath for a personal digital assistant (PDA) which has a coating that resists degeneration and detachment.

Another object of the present invention is to provide a simple method for making a protective sheath for a PDA.

A further object of the present invention is to provide a method for making a highly transparent protective sheath for a PDA.

To achieve the above-mentioned objects, a protective sheath for a PDA in accordance with the present invention comprises a lower cover and an upper cover. The upper cover comprises a window made of transparent plastic material, and two side wings made of elastomer. The window comprises a plastic base, and a coating comprising silicon oxide on a surface of the base. Adherence between the base and the coating is very firm. The window is highly transparent, has a very smooth and even surface, and has excellent wear-resistance.

A method for forming the protective sheath comprises the steps of: (1) injection molding the plastic base; (2) pre-treating the base, comprising cleaning the base using alcohol, drying the base, putting the base into an oven which has a temperature of 105 to 120 degrees Celsius for a period of 20 to 40 minutes to remove micromolecules, and taking the base out of the oven; and (3) putting the base into a vacuum chamber for plasma chemical vapor deposition (PCVD) treatment, whereby the coating comprising silicon oxide is formed on the surface of the base.

Other objects, advantages and novel features of the present invention will be drawn from the following detailed description of a preferred embodiment of the present invention with the attached drawings, in which:

### BRIEF DESCRIPTION OF THE DRAWINGS

FIG. 1 is an exploded perspective view of a protective sheath in accordance with the present invention, together with a PDA to be received in the protective sheath;

FIG. 2 is a cross-sectional view of a portion of a window of an upper cover of the protective sheath of FIG. 1, taken along line II-II of FIG. 1; and

FIG. 3 is a schematic view of an apparatus for carrying out a method in accordance with the present invention for forming a coating on the window of the protective sheath of FIG. 1.

### DESCRIPTION OF THE PREFERRED EMBODIMENT

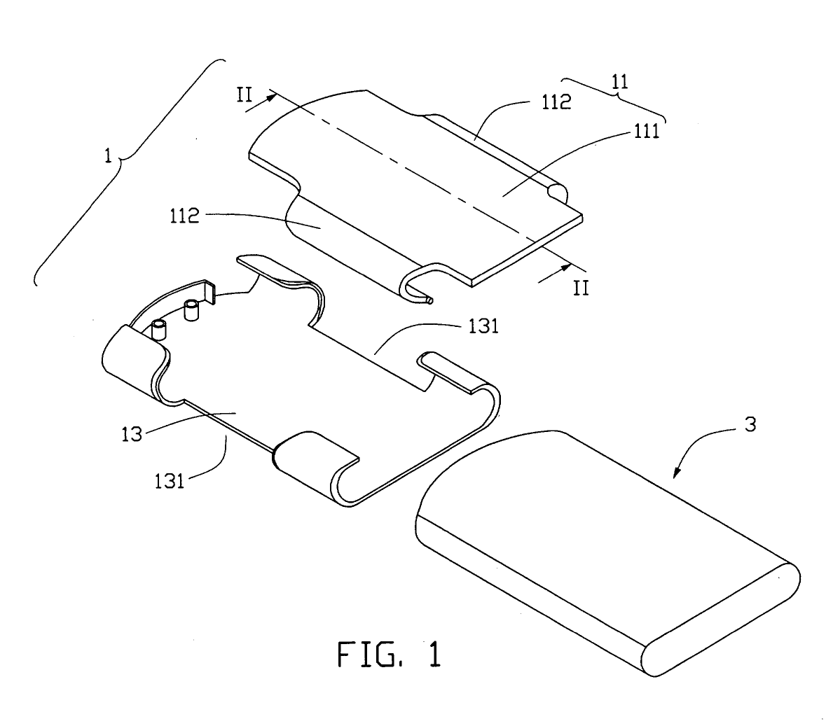

Referring to FIG. 1, a protective sheath 1 in accordance with a preferred embodiment of the present invention for a personal digital assistant (PDA) 3 comprises a lower cover 13 made of plastic and an upper cover 11. The upper cover 11 comprises a window 111 made of transparent plastic material, and two side wings 112 made of elastomer formed at opposite edges of the window 111 respectively. The window 111 is integrally formed with the wings 112 by way of insert-molding.

The lower cover 13 defines two cutouts 131 in respective opposite lateral sides thereof. In assembly of the protective sheath 1, the upper cover 11 and the lower cover 13 are attached together. The wings 112 of the upper cover 11 are fitted in the cutouts 131 of the lower cover 13. The PDA 3 is received in the protective sheath 1. The window 111 is disposed over a display screen (not shown) of the PDA 3. Since the window 111 is made of transparent plastic material, information on the display screen can be seen through the window 111.

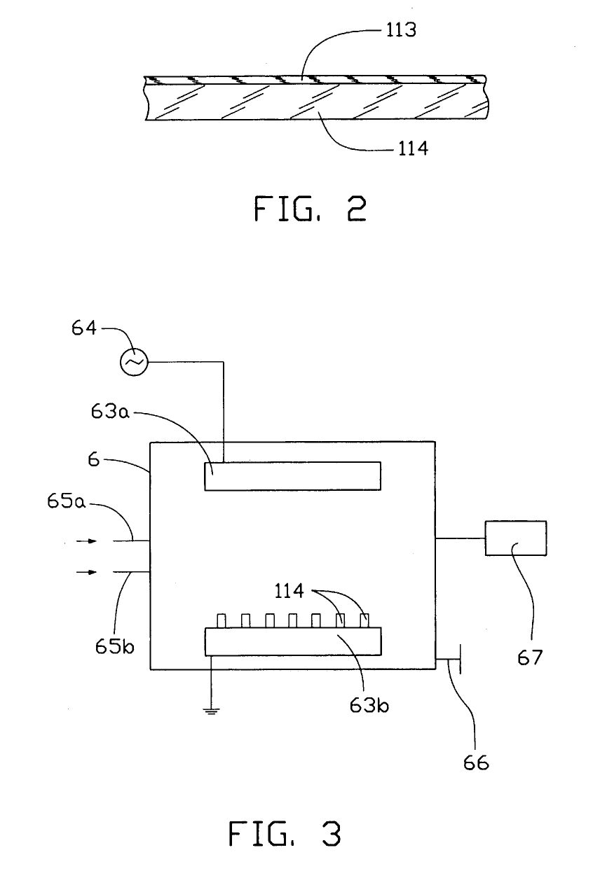

Referring to FIG. 2, the window 111 comprises a plastic base 114 and a coating 113 on an outer surface of the base 114. The coating 113 is made of silicon oxide. The plastic base 114 is made of transparent plastic material, for example, polycarbonate. Therefore, the window 111 is transparent. The coating 113 comprising silicon oxide improves surface features, such as surface hardness, corrosion-resistance, and wear-resistance of the window 111.

Referring also to FIG. 3, a method in accordance with a preferred embodiment of the present invention for forming the window 111 comprises the steps of:

(1) injection molding the plastic base 114;

(2) pre-treating the base 114, comprising cleaning the base 114 using alcohol, drying the base 114, putting the base 114 into an oven (not shown) which has a temperature of 105 to 130 degrees Celsius (° C.), and baking the base 114 for a period of 20 to 40 minutes to remove micromolecules; and

(3) taking the base 114 out of the oven and putting the base 114 into a vacuum chamber 6 for plasma chemical vapor deposition (PCVD) treatment, whereby the coating 113 comprising silicon oxide is formed on the outer surface of the base 114 to obtain the window 111.

FIG. 3 shows an apparatus for PCVD treatment of the plastic base 114 to obtain the window 111. The apparatus includes the vacuum chamber 6, a pair of electrodes 63a, 63b mounted at opposite upper and lower portions of the chamber 6 respectively, a high frequency electrical power source 64, a pair of gas inlets 65a, 65b, an exhaust port 66, and a pump 67. When radio frequency (RF) electrical power from the power source 64 is applied to the electrodes 63a, 63b, reactive gases introduced into the chamber 6 between the electrodes 63a, 63b are converted into plasma.

The electrode 63b is grounded, and serves as a table supporting the base 114. The electrode 63a is connected to the power source 64. The reactive gases are introduced into the vacuum chamber 6 via the gas inlets 65a, 65b.

The chamber 6 is connected to the pump 67, so that the chamber 6 can be pumped and thus kept at a suitable predetermined pressure. An exhaust port 66 is connected to an exhaust apparatus (not shown), whereby reacted gases can be drained out of the chamber 6 at a suitable predetermined rate.

The PCVD treatment of the base 114 in the chamber 6 to form the coating 113 and thereby obtain the window 111 comprises the following steps:

1. The base 114 is placed on the electrode 63b in the chamber 6. The chamber 6 is closed, and pumped by the pump 67 such that a pressure of 5 millitorrs (mtorr) or less is obtained and maintained in the chamber 6.

2. Reactive gas 1,1,3,3-tetramethyldisiloxane (TMDS) is introduced into the chamber 6 via the gas inlet 65a at a volumetric flow rate of between 50 and 150 standard cubic centimeters per minute (SCCM). RF power from the power source 64 having a magnitude of 300 watts (W) and a frequency of 298 to 300 megahertz (MHz) is applied to the electrodes 63a, 63b. After the power is applied for five minutes, oxygen is introduced into the chamber 6 via the gas inlet 65b at a volumetric flow rate of between 200 and 300 SCCM.

3. Once a pressure of 50 to 55 mtorr in the chamber 6 is obtained, no more reactive gases are introduced. The volume of oxygen is in the range of 65% to 75% of the total reactive gases, and the volume of TMDS is in the range of 25% to 35% of the total reactive gases. Preferably, a ratio of volumes between the oxygen and the TMDS is approximately 7:2.

4. The RF power having a magnitude of 300 W is switched to 600 W, and the frequency is adjusted to be in the range of between 598 and 600 MHz. The reactive gases oxygen and TMDS which flow between the electrodes 63a, 63b are ionized into an ionized plasma. The plasma reacts with a surface of the base 114, and the coating 113 comprising silicon oxide is formed on the upper surface of the base 114. The window 111 for the protective sheath 1 is thus obtained. The RF electrical power is applied to the electrodes 63a, 63b for about 25 minutes; therefore, the reaction between the plasma and the upper surface of the base 114 proceeds for about 25 minutes.

5. The exhaust port 66 is opened to drain the wasted gases from the chamber 6. Finally, the window 11 is taken out from the chamber 6 after it has cooled.

The coating 113 on the upper surface of the base 114 of the window 111 is highly transparent and has a very smooth surface and even thickness. In the preferred embodiment, the coating 113 has a thickness in the range from 3.5 to 4.0 micrometers (μm). Tests have established that the window 111 has excellent wear-resistance, and that adherence between the base 114 and the coating 113 is very firm.

It is believed that the present invention and its advantages will be understood from the foregoing description, and it will be apparent that various changes may be made thereto without departing from the spirit and scope of the invention or sacrificing all of its material advantages. Accordingly, the example hereinbefore described is to be understood as being a preferred or exemplary embodiment of the invention.

What is claimed is:

1. A protective sheath for receiving a portable electronic device therein and protecting the portable electronic device from being scratched, comprising:
an upper cover, comprising a window made of plastic material and two side wings made of elastomer integrally formed at two opposite edges of the window, respectively, wherein the window includes a transparent plastic base and at least one transparent coating comprising silicon oxide on the base; and
a lower cover engaging with the upper cover.

2. The protective sheath of claim 1, wherein the plastic base is made of polycarbonate.

3. The protective sheath of claim 1, wherein a thickness of the coating comprising silicon oxide is in the range from 3.5 to 4.0 micrometers.

4. A method for making a protective sheath for receiving a portable electronic device therein and protecting the portable electronic device from being scratched, comprising the steps of:
(1) injection molding a plastic base;
(2) pre-treating the base, comprising cleaning and pre-heating the base; and
(3) putting the pre-treated base in a vacuum chamber for plasma chemical vapor deposition treatment;
whereby a coating comprising silicon oxide is formed on a surface of the base.

5. The method of claim 4, wherein in step (2) the pre-treating process comprises cleaning the base using alcohol, drying the base, putting the base into an oven which has a temperature in the range from 105 to 130 degrees Celsius for a period of 20 to 40 minutes, and taking the base out of the oven for plasma chemical vapor deposition treatment thereafter.

6. The method of claim 4, wherein in step (3) the plasma chemical vapor deposition treatment comprises the steps of:
(1) creating a vacuum in the chamber;
(2) introducing reactive gases into the chamber, said reactive gases comprising 1,1,3,3-tetramethyldisiloxane and oxygen;
(3) maintaining a predetermined pressure in the chamber;
(4) applying high electrical power to cause the reactive gases to become an ionized plasma, said plasma reacting with a surface of the base to form a coating comprising silicon oxide thereon; and
(5) draining reacted gases from the chamber.

7. The method of claim 6, wherein the chamber is maintained below a pressure of 5 millitorrs.

8. The method of claim 6, wherein in step (2) 1,1,3,3-tetramethyldisiloxane is introduced into the chamber first, a volumetric flow rate of 1,1,3,3-tetramethyldisiloxane is maintained in the range from 50 to 150 standard cubic centimeters per minute, oxygen is introduced into the chamber after approximately 5 minutes at a volumetric flow rate in the range from 200 to 300 standard cubic centimeters per minute, and a ratio of volumes of oxygen and 1,1,3,3-tetramethyldisiloxane is approximately 7:2.

9. The method of claim 6, wherein in step (2) high electrical power of 300 watts is provided, and the power has a frequency in the range from 298 to 300 megahertz.

10. The method of claim 6, wherein in step (3) the predetermined pressure is in the range from 50 to 55 mtorrs.

11. The method of claim 6, wherein in step (4) the electrical power is approximately 600 watts, the power has a frequency in the range from 598 to 600 megahertz, and the plasma chemical vapor deposition treatment is continued for approximately 25 minutes.

12. An electronic device assembly comprising:
a protective sheath including:
a lower cover;
an upper cover pivotally engaged with the lower cover and comprising a window with a transparent plastic base;
at least one transparent coating comprising silicon oxide applied on the base;
two side wings made of elastomer integrally formed at two opposite sides of the window, respectively; and
an electronic device removeably received within a spaced defined between the upper cover and the lower cover.
